(19) United States
(12) Patent Application Publication
(10) Pub. No.: US 2024/0005246 A1
(43) Pub. Date: Jan. 4, 2024

(54) WORK SUPPORT SYSTEM, WORK SUPPORT METHOD, AND WORK SUPPORT PROGRAM

(71) Applicant: TOYOTA JIDOSHA KABUSHIKI KAISHA, Toyota-shi (JP)

(72) Inventors: Noriaki SAKAI, Nishin-shi (JP); Nagisa TANAKA, Toyota-shi (JP)

(73) Assignee: TOYOTA JIDOSHA KABUSHIKI KAISHA, Toyota-shi, Aichi-ken (JP)

(21) Appl. No.: 18/214,855

(22) Filed: Jun. 27, 2023

(30) Foreign Application Priority Data
Jun. 30, 2022 (JP) 2022-105241

(51) Int. Cl. G06Q 10/0633

(52) U.S. Cl. CPC G06Q 10/0633; G06Q 50/06

(57) ABSTRACT

A work support system includes: a travel route setting unit that sets travel routes for workers respectively assigned to a plurality of pieces of predetermined work to execute the respective pieces of predetermined work; a work flow calculation unit that calculates a work flow showing a flow in which each of the plurality of pieces of predetermined work is executed based on a condition for starting execution of each of the pieces of predetermined work, an execution time of each of the pieces of predetermined work, and a travel time during which the workers travel through the respective travel routes to execute the respective pieces of the predetermined work; and an output unit that outputs a result of the calculation, in which the travel route setting unit dynamically sets the travel routes in accordance with a work environment that changes as the plurality of pieces of predetermined work are executed.

### CROSS REFERENCE TO RELATED APPLICATIONS

This application is based upon and claims the benefit of priority from Japanese patent application No. 2022-105241, filed on Jun. 30, 2022, the disclosure of which is incorporated herein in its entirety by reference.

### BACKGROUND

The present disclosure relates to a work support system, a work support method, and a work support program.

In recent years, there has been a demand that an appropriate work flow be proposed to a user such as a contractor in order to enable a plurality of pieces of predetermined work included in construction work to be efficiently executed.

Japanese Patent No. 5414601 discloses a construction plan preparation apparatus that can prepare a construction plan by which work is reliably completed within a specified period of time and in which a working efficiency is high.

### SUMMARY

The apparatus disclosed in Japanese Patent No. 5414601 prepares a construction plan in which traveling of workers has not been taken into account, and therefore may not be able to prepare a highly accurate construction plan (work flow).

The present disclosure has been made in view of the aforementioned circumstances and an object thereof is to provide a work support system, a work support method, and a work support program that are capable of proposing a highly accurate work flow.

A first exemplary aspect is a work support system including: a travel route setting unit configured to set travel routes for workers respectively assigned to a plurality of pieces of predetermined work to execute the respective pieces of predetermined work; a work flow calculation unit configured to calculate a work flow showing a flow in which each of the plurality of pieces of predetermined work is executed based on at least a condition for starting execution of each of the pieces of predetermined work, an execution time of each of the pieces of predetermined work, and a travel time during which the workers travel through the respective travel routes to execute the respective pieces of the predetermined work; and an output unit configured to output a result of the calculation performed by the work flow calculation unit, in which the travel route setting unit dynamically sets the travel routes in accordance with a work environment that changes as the plurality of pieces of predetermined work are executed. Since the work support system can perform a simulation using information about travel routes that closely resemble the actual travel routes, the work support system can propose a highly accurate work flow to a user such as a construction client. Note that the work support system can improve performance of the simulation through machine learning.

Another exemplary aspect is a work support method including: setting travel routes for workers respectively assigned to a plurality of pieces of predetermined work to execute the respective pieces of predetermined work; calculating a work flow showing a flow in which each of the plurality of pieces of predetermined work is executed based on at least a condition for starting execution of each of the pieces of predetermined work, an execution time of each of the pieces of predetermined work, and a travel time during which the workers travel through the respective travel routes to execute the respective pieces of the predetermined work; and outputting a result of the calculation, in which in the setting of the travel routes, the travel routes are dynamically set in accordance with a work environment that changes as the plurality of pieces of predetermined work are executed. Since the work support method can perform a simulation using information about travel routes that closely resemble the actual travel routes, the work support method can propose a highly accurate work flow to a user such as a construction client.

Another exemplary aspect is a work support program for causing a computer to: set travel routes for workers respectively assigned to a plurality of pieces of predetermined work to execute the respective pieces of predetermined work; calculate a work flow showing a flow in which each of the plurality of pieces of predetermined work is executed based on at least a condition for starting execution of each of the pieces of predetermined work, an execution time of each of the pieces of predetermined work, and a travel time during which the workers travel through the respective travel routes to execute the respective pieces of the predetermined work; and output a result of the calculation, in which in the setting of the travel routes, the travel routes are dynamically set in accordance with a work environment that changes as the plurality of pieces of predetermined work are executed. Since the work support program can perform a simulation using information about travel routes that closely resemble the actual travel routes, the work support program can propose a highly accurate work flow to a user such as a construction client.

According to the present disclosure, it is possible to provide a work support system, a work support method, and a work support program that are capable of proposing a highly accurate work flow.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram showing an example of a configuration of a work support system according to a first embodiment;

FIG. 2 is a flowchart showing a simulation operation performed by the work support system shown in FIG. 1;

FIG. 3A is a diagram for explaining a specific example of a simulation operation related to execution of a predetermined work by the work support system shown in FIG. 1;

FIG. 3B is a diagram for explaining a specific example of a simulation operation related to execution of a predetermined work by the work support system shown in FIG. 1;

FIG. 3C is a diagram for explaining a specific example of a simulation operation related to execution of a predetermined work by the work support system shown in FIG. 1;

FIG. 4A is a diagram for explaining a specific example of the simulation operation related to execution of a predetermined work by the work support system shown in FIG. 1;

FIG. 4B is a diagram for explaining a specific example of the simulation operation related to execution of a predetermined work by the work support system shown in FIG. 1;

FIG. 4C is a diagram for explaining a specific example of the simulation operation related to execution of a predetermined work by the work support system shown in FIG. 1;

FIG. 5A is a diagram for explaining a specific example of the simulation operation related to execution of a predetermined work by the work support system shown in FIG. 1;

FIG. 5B is a diagram for explaining a specific example of the simulation operation related to execution of a predetermined work by the work support system shown in FIG. 1;

FIG. 6A is a diagram for explaining a specific example of the simulation operation related to execution of a predetermined work by the work support system shown in FIG. 1;

FIG. 6B is a diagram for explaining a specific example of the simulation operation related to execution of a predetermined work by the work support system shown in FIG. 1;

FIG. 6C is a diagram for explaining a specific example of the simulation operation related to execution of a predetermined work by the work support system shown in FIG. 1;

FIG. 7A is a diagram for explaining a specific example of the simulation operation related to execution of a predetermined work by the work support system shown in FIG. 1;

FIG. 7B is a diagram for explaining a specific example of the simulation operation related to execution of a predetermined work by the work support system shown in FIG. 1;

FIG. 8 is a diagram showing an example of a result of a simulation performed by the work support system shown in FIG. 1; and

FIG. 9 is a diagram showing another example of a result of a simulation performed by the work support system shown in FIG. 1.

### DESCRIPTION OF EMBODIMENTS

The present disclosure will be described hereinafter with reference to an embodiment of the present disclosure. However, the following embodiment is not intended to limit the scope of the disclosure according to the claims. Further, all the components/structures described in the embodiment are not necessarily indispensable as means for solving the problem. For the clarification of the description, the following descriptions and the drawings are partially omitted and simplified as appropriate. The same elements are denoted by the same reference numerals or symbols throughout the drawings, and redundant descriptions are omitted as necessary.

### First Embodiment

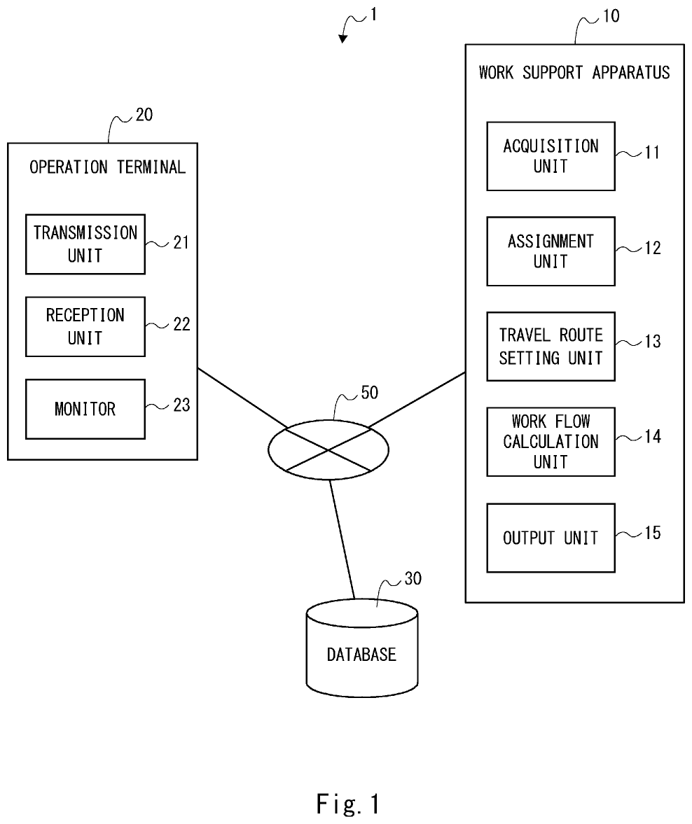

FIG. 1 is a block diagram showing an example of a configuration of a work support system 1 according to a first embodiment. The work support system 1 according to this embodiment is a system for performing a simulation related to execution of each of a plurality of pieces of predetermined work included in construction work, to thereby enable an appropriate work flow to be proposed to a user such as a contractor. Note that the work support system 1 according to this embodiment dynamically sets, in accordance with a work environment that changes as the plurality of pieces of predetermined work included in the construction work are executed, travel routes for workers to execute the respective pieces of predetermined work. By the above configuration, the work support system 1 according to this embodiment can perform a simulation using information about travel routes that closely resemble the actual travel routes, and therefore can propose a highly accurate work flow to a user. The details of the above configuration will be described below.

As shown in FIG. 1, the work support system 1 includes a work support apparatus 10, an operation terminal 20, a database 30, and a network 50. The work support apparatus 10 can also be referred to as the work support system 1. The operation terminal 20, the database 30, and the work support apparatus 10 are configured so that they can communicate with one another through the wired or the wireless network 50. Note that, in this embodiment, a description will be given of a case in which the work support apparatus 10 and the operation terminal are separately provided. However, the present disclosure is not limited thereto; for example, the work support apparatus 10 may have the functions of the operation terminal 20. That is, the work support apparatus 10 and the operation terminal 20 may be integrally formed.

The operation terminal 20 may be, for example, a Personal Computer (PC) terminal or a dedicated communication terminal prepared for the work support system 1.

The operation terminal 20 includes at least a transmission unit 21, a reception unit 22, and a monitor 23. For example, a user such as a construction client or a contractor who has been requested to perform construction work inputs information about construction work, information about resources that can be allocated to construction work, and the like to the operation terminal 20 by operating an operation screen, a keyboard, and the like of the operation terminal 20. The transmission unit 21 receives, for example, the information about construction work and the information about resources that can be allocated to construction work input by a user's operation, and transmits them to the work support apparatus 10 through the network 50. The reception unit 22 receives a result of a simulation output from the work support apparatus 10 through the network 50. The monitor 23 displays the result of a simulation received by the reception unit 22.

Note that the information about construction work includes information about a plurality of pieces of predetermined work included in the construction work, the minimum number of workers required, the minimum kinds of work tools required, the minimum number of each of the kinds of the work tools required, the minimum kinds of construction machines required, the minimum number of each of the kinds of the construction machines required, a scheduled completion date, a budget, and the like. The information about construction work may also include qualifications, years of work experience, and the like required for workers. The construction work may include, for example, assembly of automobiles in an automobile factory and replacement of installed objects.

Further, the information about resources that can be allocated to construction work includes the number of workers that can be allocated to the construction work, the types and the number of construction machines that can be allocated to the construction work, and the like. Note that the number of types of information about resources that can be allocated to construction work is not limited to one. That is, there may be a plurality of types of information about resources that can be allocated to construction work. By the above configuration, the work support apparatus 10 can propose a plurality of types of work flows according to the plurality of respective types of information about resources.

The work support apparatus 10 performs a simulation related to execution of each of a plurality of pieces of predetermined work included in construction work, and outputs, as a result of the simulation, a work flow showing a flow in which each of the plurality of pieces of predetermined work included in the construction work is executed.

Specifically, the work support apparatus 10 includes at least an acquisition unit 11, an assignment unit 12, a travel route setting unit 13, a work flow calculation unit 14, and an output unit 15.

The acquisition unit 11 acquires information transmitted from the operation terminal 20. Specifically, the acquisition unit 11 acquires information about construction work and information about resources that can be allocated to the construction work. The acquisition unit 11 also acquires information stored in the database 30. The database 30 stores, for example, information about a condition for starting execution of each of the pieces of predetermined work and information about a working time of each of a plurality of unit works composing each of the pieces of predetermined work.

The assignment unit 12 assigns one or more workers to each of the plurality of pieces of predetermined work included in construction work. For example, the assignment unit 12 assigns one or more workers, that is, first workers, to a first predetermined work which is one of the plurality of pieces of predetermined work included in the construction work, and assigns one or more workers, that is, second workers, to a second predetermined work which is one of the plurality of pieces of predetermined work included in the construction work other than the first predetermined work. Note that when the acquisition unit 11 acquires assignment information of workers with regard to each of the plurality of pieces of predetermined work, assignment processing performed by the assignment unit 12 is not required. Therefore, when it is assumed that the acquisition unit 11 acquires assignment information of workers with regard to each of the plurality of pieces of predetermined work, the assignment unit 12 is not required.

The travel route setting unit 13 sets a travel route for a worker to execute predetermined work. For example, the travel route setting unit 13 sets a first travel route, which is a travel route for execution of the first predetermined work by the first worker to whom the first predetermined work has been assigned, and a second travel route, which is a travel route for execution of the second predetermined work by the second worker to whom the second predetermined work has been assigned.

The work flow calculation unit 14 calculates a work flow showing a flow in which each of the plurality of pieces of predetermined work is executed based on at least a condition for starting execution of each of the pieces of predetermined work, an execution time of each of the pieces of predetermined work, and a travel time during which the workers travel through the respective travel routes to execute the respective pieces of the predetermined work. Note that the execution time of each of the pieces of predetermined work is calculated based on the working time of each of a plurality of unit works composing each of the pieces of predetermined work, which is stored in the database 30. Further, the travel time during which workers travel through the respective travel routes is calculated based on the lengths of the travel routes etc. The condition for starting execution of each of the pieces of predetermined work is, for example, completion of preparation for the execution of each of the pieces of predetermined work by workers, completion of execution of other pieces of predetermined work to be executed before the execution of each of the pieces of predetermined work, and the like.

Note that the travel route setting unit 13 dynamically sets, in accordance with a work environment that changes as the plurality of pieces of predetermined work are executed, travel routes for workers to execute the respective pieces of predetermined work. By the above configuration, the work flow calculation unit 14 can perform a simulation using information about travel routes that closely resemble the actual travel routes, and therefore can propose a highly accurate work flow to a user.

Note that a work environment that changes as a plurality of pieces of predetermined work included in construction work are executed is, for example, a work area for each worker that changes as a plurality of pieces of predetermined work are executed, and specifically, in panel replacement work, a work area of a transporting truck that changes as a plurality of old panels are loaded one by one into the transporting truck and as a plurality of new panels are unloaded one by one from the transporting truck.

The output unit 15 outputs a result of the calculation performed by the work flow calculation unit 14 as a result of the simulation. Information output from the output unit 15 is, for example, transferred to the operation terminal 20 through the network 50, and displayed on the monitor 23 of the operation terminal or output by voice from a speaker (not shown). Therefore, the output unit 15 can also be referred to as a transmission unit that transmits information to an external terminal. By the above configuration, a user such as a construction client or a contractor who has been requested to perform construction work can know a work flow that is a result of the simulation performed by the work support apparatus 10.

As described above, the work support system 1 according to this embodiment dynamically sets, in accordance with a work environment that changes as the plurality of pieces of predetermined work included in the construction work are executed, travel routes for workers to execute the respective pieces of predetermined work. By the above configuration, the work support system 1 according to this embodiment can perform a simulation using information about travel routes that closely resemble the actual travel routes, and therefore can propose a highly accurate work flow to a user.

### (Operations Performed by the Work Support System 1)

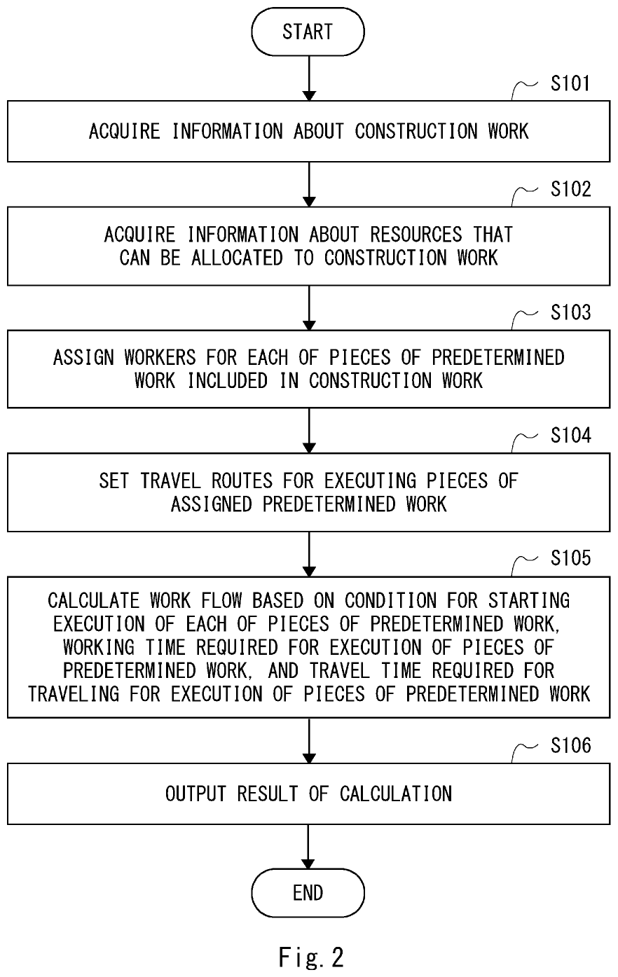

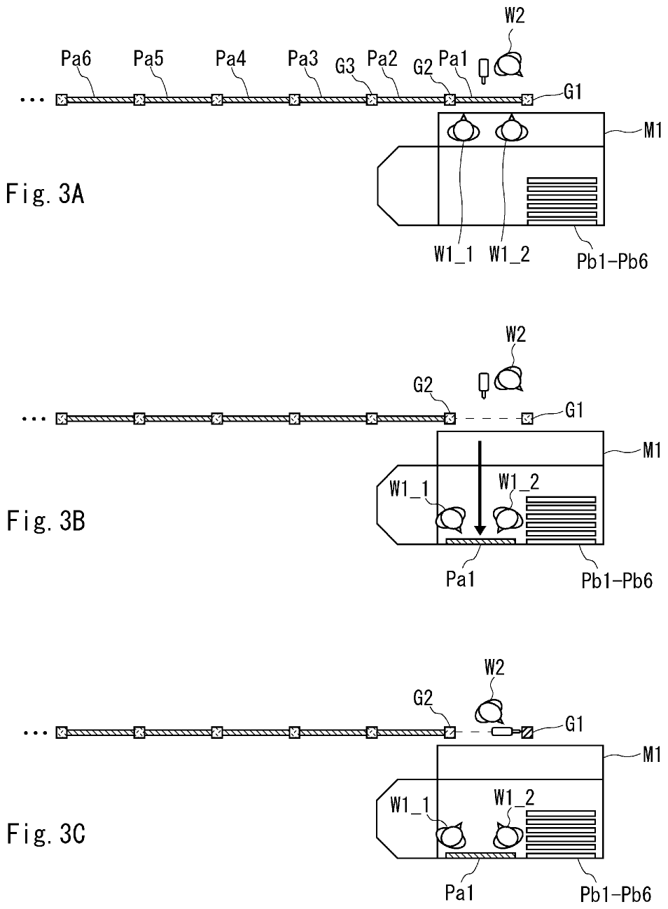

Next, operations performed by the work support system 1 will be described with reference to FIGS. 2 to 7. FIG. 2 is a flowchart showing a simulation operation performed by the work support system 1. Each of FIGS. 3 to 7 is a diagram for explaining a specific example of the simulation operation related to execution of predetermined work by the work support system 1.

First, in the work support apparatus 10, the acquisition unit 11 acquires information about construction work and information about resources that can be allocated to construction work transmitted from the operation terminal 20 (Steps S101 and S102). The acquisition unit 11 also acquires information about a condition for starting execution of each of pieces of predetermined work and information about a working time of each of a plurality of unit works composing each of the pieces of predetermined work stored in the database 30.

Note that the information about construction work includes information about a plurality of pieces of predetermined work included in the construction work, the minimum number of workers required, the minimum kinds of work tools required, the minimum number of each of the kinds of the work tools required, the minimum kinds of construction machines required, the minimum number of each of the kinds of the construction machines required, a scheduled completion date, a budget, and the like. Further, the information about construction work may also include qualifications, years of work experience, and the like required for workers. The construction work may include, for example, assembly of automobiles in an automobile factory and replacement of installed objects.

In this embodiment, a description will be given of an example of a case in which a construction work is replacement of a plurality of solar panels installed on the sides of a highway. This construction work includes, as a plurality of pieces of predetermined work, work of removing an old panel, work of making holes in support pillars in order to secure a new panel to the support pillars with screws, and work of attaching the new panel. In the following description, work of removing an old panel and work of attaching a new panel are collectively referred to as panel replacement work. Further, in this embodiment, a description will be given of an example of a case in which the minimum number of workers required is three, the minimum kinds of work tools required is one, namely, an electrically-powered drill, the minimum number of the work tools required is one, the minimum kinds of construction machines required is one, namely, a four-ton truck for transporting panels, and the minimum number of the construction machines required is one.

Further, in this embodiment, a description will be given of a case in which resources that can be allocated to the construction work are three workers, one electrically-powered drill, and one four-ton truck for transporting panels. However, regarding the resources that can be allocated to the construction work, for example, information indicating that a kind of a construction machine that can be allocated to the construction work is a four-ton truck and the number of the four-ton trucks is only one and information indicating that a kind of a construction machine that can be allocated to the construction work is an eight-ton truck and the number of the eight-ton trucks is only one may be input as the kinds and the number of construction machines that can be allocated to the construction work. By doing so, the work support apparatus 10 can propose a work flow using one four-ton truck and a work flow using one eight-ton truck.

Then, the assignment unit 12 assigns one or more workers for each of the plurality of pieces of predetermined work included in the construction work (Step S103). For example, regarding the panel replacement work (work including work of removing an old panel and work of attaching a new panel) and work of making holes in support pillars included in the construction work, the assignment unit 12 assigns the panel replacement work to two workers W1_1 and W1_2 and the work of making holes in support pillars to one worker W2.

Then, the travel route setting unit 13 sets travel routes of the workers for executing the pieces of predetermined work (Step S104). For example, the travel route setting unit 13 sets travel routes of the workers W1_1 and W1_2 for executing the panel replacement work, and a travel route for the worker W2 to execute the work of making holes in support pillars.

Then, the work flow calculation unit 14 calculates a work flow showing a flow in which each of the plurality of pieces of predetermined work is executed based on at least a condition for starting execution of each of the pieces of predetermined work, an execution time of each of the pieces of predetermined work, and a travel time during which the workers travel through the respective travel routes to execute the respective pieces of the predetermined work (Step S105). For example, the work flow calculation unit 14 calculates a work flow such that the workers W1_1 and W1_2 execute the work of removing an old panel, the worker W2 executes the work of making holes in support pillars after the removal of the old panels is completed, and the workers W1_1 and W1_2 execute the work of attaching a new panel after the work of making holes in support pillars is completed.

Note that the travel route setting unit 13 dynamically sets, in accordance with a work environment that changes as the plurality of pieces of predetermined work are executed, travel routes for workers to execute the respective pieces of predetermined work. For example, in the panel replacement work, a work area on a transporting truck changes as a plurality of old panels are loaded one by one into the transporting truck and as a plurality of new panels are unloaded one by one from the transporting truck. Therefore, the travel route setting unit 13 dynamically sets travel routes for the workers W1_1 and W1_2 to execute the panel replacement work in accordance with the work area that changes as the panel replacement work is executed. By the above configuration, the work flow calculation unit 14 can perform a simulation using information about travel routes that closely resemble the actual travel routes, and therefore can propose a highly accurate work flow to a user.

More specifically, when the construction work is a replacement old panels Pa1 to Pa6 with new panels Pb1 to Pb6, simulation operations related to the panel replacement work and the work of making holes in support pillars are performed, for example, by the following procedure.

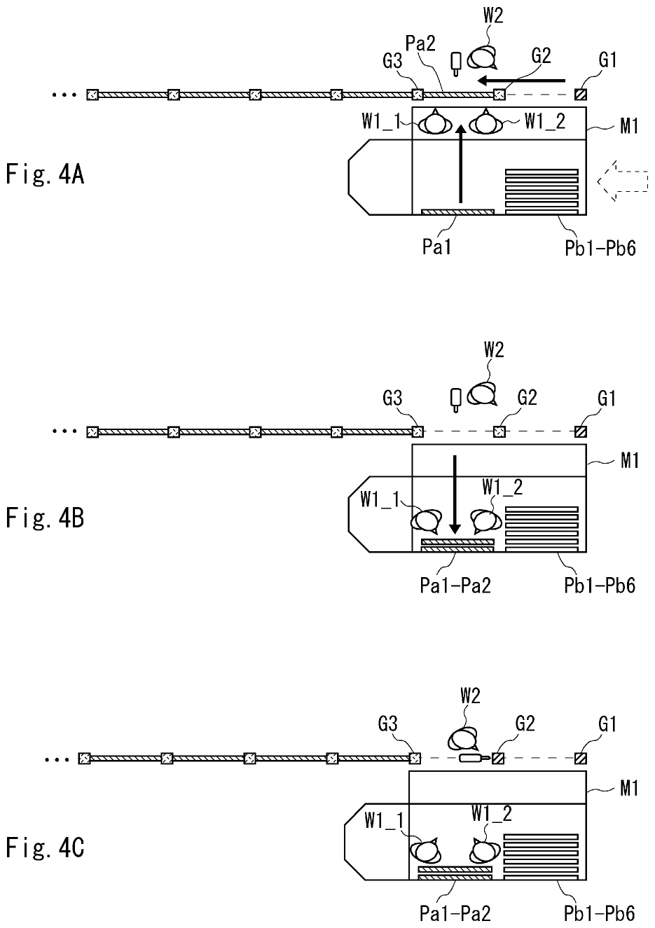

First, a truck M1 on which the new panels Pb1 to Pb6 are loaded moves to an area near the area where the old panels Pa1 to Pa6 are installed. Then, it is determined whether or not there is an old panel on the left side of the surface (hereinafter simply referred to as a frontage) of the work area on the truck M1 that comes into contact with the area where the old panels Pa1 to Pa6 are installed. For example, in a case in which the old panel Pa1 is present on the left side of the frontage (see FIG. 3A), the workers W1_1 and W1_2, after travel routes for the workers W1_1 and W1_2 from the old panel Pa1 to an old panel storage area are set, remove the old panel Pa1 from support pillars G1 and G2 and load it into the truck M1 while traveling along the set travel routes (see FIG. 3B). At this time, the worker W2 waits until the old panel Pa1 is removed, and after the old panel Pa1 is removed, the worker W2 performs the work of making holes in the support pillar G1 (see FIG. 3C). When the work of making holes in the support pillar G1 is completed, it is determined whether or not there is a region where a panel has been removed on the right side of the frontage of the truck M1. In this example, since the region where a panel has been removed is not present on the right side of the frontage of the truck M1, the work of attaching a new panel is not performed and the truck M1 moves to an area near the old panel Pa2 (see FIG. 4A). At this time, after the respective travel routes for the workers W1_1, W1_2, and W2 are set, the workers W1_1, W1_2, and W2 travel to the next work point along their respective travel routes (see FIG. 4A).

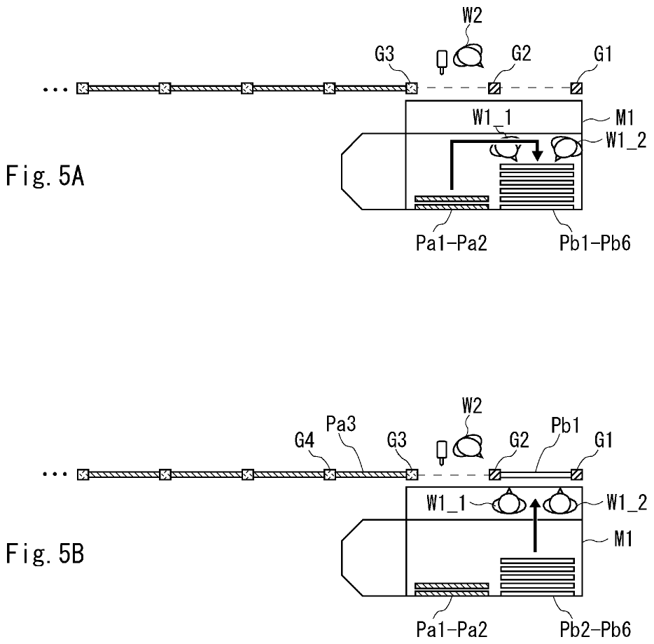

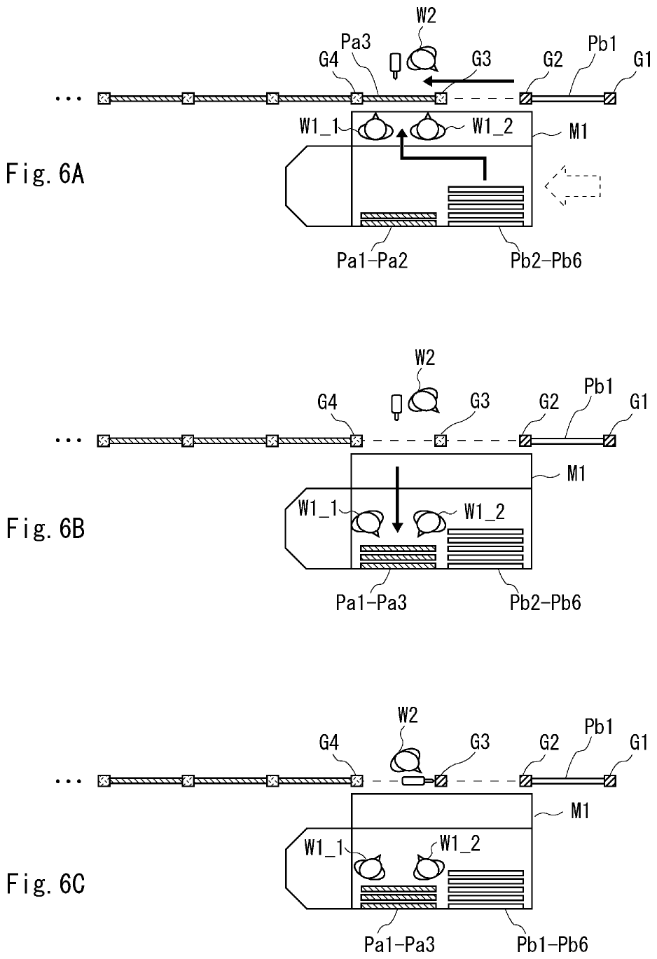

After the truck M1 is moved, it is determined whether or not an old panel is present on the left side of the frontage of the truck M1. For example, in a case in which the old panel Pa2 is present on the left side of the frontage (see FIG. 4A), the workers W1_1 and W1_2, after travel routes for the workers W1_1 and W1_2 from the old panel Pa2 to the old panel storage area are set, remove the old panel Pa2 from the support pillar G2 and a support pillar G3 and load it into the truck M1 while traveling along the set travel routes (see FIG. 4B). At this time, the worker W2 waits until the old panel Pa2 is removed, and after the old panel Pa2 is removed, the worker W2 performs the work of making holes in the support pillar G2 (see FIG. 4C). When the work of making holes in the support pillar G2 is completed, it is determined whether or not there is a region where a panel has been removed on the right side of the frontage of the truck M1. When the region where a panel has been removed is present on the right side of the frontage of the truck M1, it is then determined whether or not the work of making holes in the support pillars on both sides of the region where a panel has been removed is completed. In this example, since the region where a panel has been removed is present on the right side of the frontage of the truck M1 and the work of making holes in the support pillars G1 and G2 on both sides of the region where a panel has been removed has been completed, the work of attaching the new panel Pb1 to the support pillars G1 and G2 is performed. Specifically, first, after travel routes for the workers W1_1 and W1_2 from the old panel storage area to a new panel storage area are set, the workers W1_1 and W1_2 travel along the set travel routes from the old panel storage area to the new panel storage area (see FIG. 5A). Then, after travel routes for the workers W1_1 and W1_2 from the new panel storage area to a work point near the frontage are set, the workers W1_1 and W1_2 unload the new panel Pb1 from the truck M1 and attach it to the support pillars G1 and G2 while traveling along the set travel routes (see FIG. 5B). When the work of attaching the new panel Pb1 is completed, the truck M1 moves to an area near the old panel Pa3 (see FIG. 6A). At this time, after the respective travel routes for the workers W1_1, W1_2, and W2 are set, the workers W1_1, W1_2, and W2 travel to the next work point along their respective travel routes (see FIG. 6A).

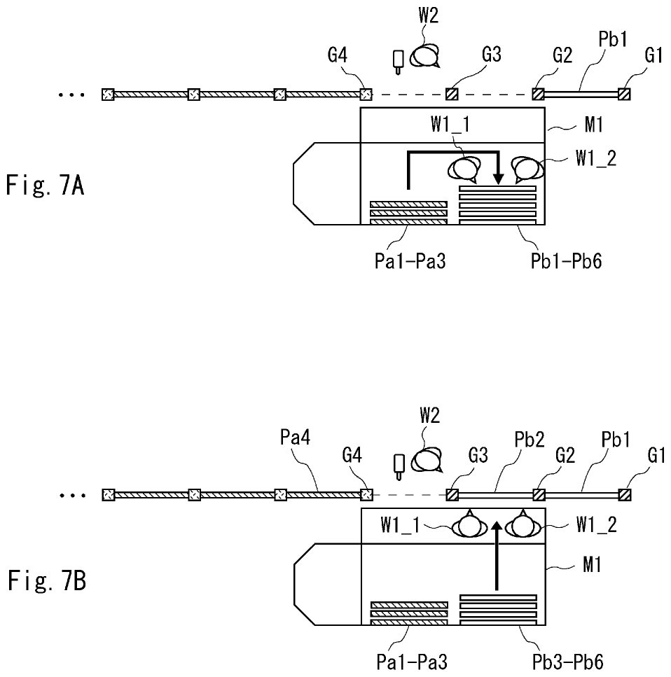

After the truck M1 is moved, it is determined whether or not an old panel is present on the left side of the frontage of the truck M1. For example, in a case in which the old panel Pa3 is present on the left side of the frontage (see FIG. 6A), the workers W1_1 and W1_2, after travel routes for the workers W1_1 and W1_2 from the old panel Pa3 to the old panel storage area are set, remove the old panel Pa3 from the support pillar G3 and a support pillar G4 and load it into the truck M1 while traveling along the set travel routes (see FIG. 6B). At this time, the worker W2 waits until the old panel Pa3 is removed, and after the old panel Pa3 is removed, the worker W2 performs the work of making holes in the support pillar G3 (see FIG. 6C). When the work of making holes in the support pillar G3 is completed, it is determined whether or not there is a region where a panel has been removed on the right side of the frontage of the truck M1. When the region where a panel has been removed is present on the right side of the frontage of the truck M1, it is then determined whether or not the work of making holes in the support pillars on both sides of the region where a panel has been removed is completed. In this example, since the region where a panel has been removed is present on the right side of the frontage of the truck M1 and the work of making holes in the support pillars G2 and G3 on both sides of the region where a panel has been removed has been completed, the work of attaching the new panel Pb2 to the support pillars G2 and G3 is performed. Specifically, first, after travel routes for the workers W1_1 and W1_2 from the old panel storage area to the new panel storage area are set, the workers W1_1 and W1_2 travel along the set travel routes from the old panel storage area to the new panel storage area (see FIG. 7A). Then, after travel routes for the workers W1_1 and W1_2 from the new panel storage area to a work point near the frontage are set, the workers W1_1 and W1_2 unload the new panel Pb2 from the truck M1 and attach it to the support pillars G2 and G3 while traveling along the set travel routes (see FIG. 7B). When the work of attaching the new panel Pb2 is completed, the truck M1 moves to an area near the old panel Pa4. At this time, after the respective travel routes for the workers W1_1, W1_2, and W2 are set, the workers W1_1, W1_2, and W2 travel to the next work point along their respective travel routes.

The above-described simulation operations are repeated until the old panel Pa6 is replaced with the new panel Pb6. In this way, in accordance with a work area etc. that change as the panel replacement work is executed, travel routes for the workers W1_1 and W1_2 to execute the panel replacement work and a travel route for the worker W2 to execute the work of making holes in the support pillars are dynamically set.

Then, the output unit 15 outputs a result of the calculation performed by the work flow calculation unit 14 as a result of the simulation (Step S106). Information output from the output unit 15 is, for example, transferred to the operation terminal 20 through the network 50 and displayed on the monitor 23 of the operation terminal 20. By the above configuration, a user such as a construction client or a contractor who has been requested to perform construction work can know a work flow that is a result of the simulation performed by the work support apparatus 10.

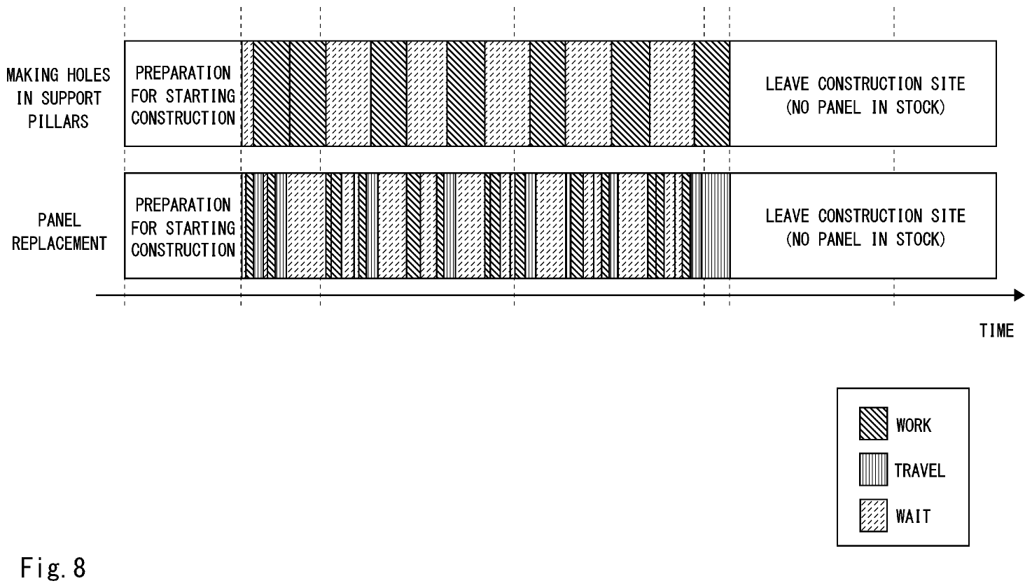

FIG. 8 is a diagram showing an example of a work flow displayed on the monitor 23. The example in FIG. 8 shows a flow in which a worker to whom work of making holes in support pillars has been assigned executes the work of making holes in the support pillars, the worker travels, and the worker waits, and a flow in which a worker to whom the panel replacement work has been assigned executes the panel replacement work, the worker travels, and the worker waits. Note that, in the example shown in FIG. 8, a four-ton truck is used as a truck for transporting panels, and the number of new panels that can be placed on the truck is limited and hence the stock of new panels on the truck has run out before replacement of all the panels is completed.

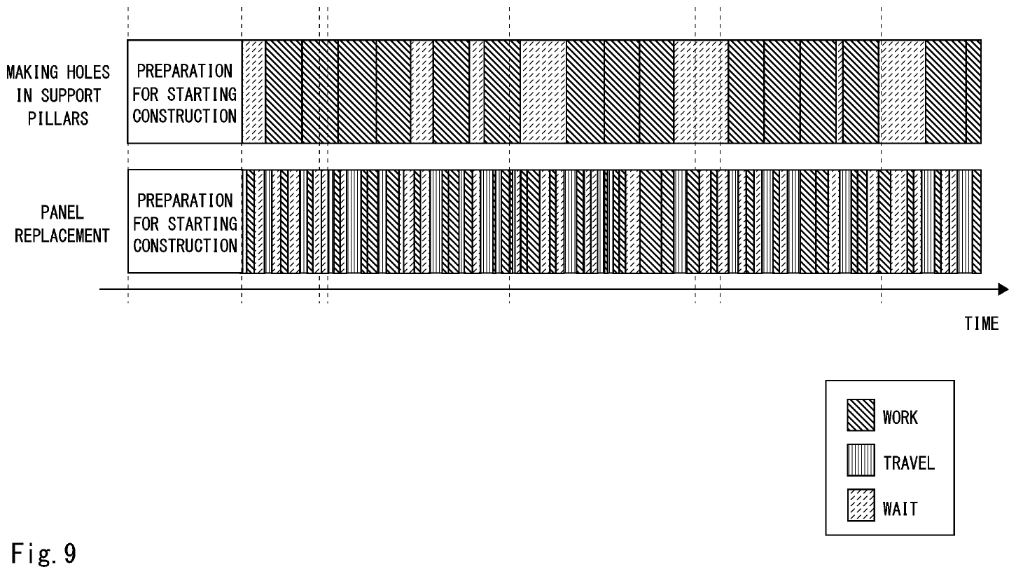

FIG. 9 is a diagram showing another example of the work flow displayed on the monitor 23. The example in FIG. 9 shows a result of the simulation when an eight-ton truck is used as a truck for transporting panels, and since the number of new panels that can be placed on the truck is larger than that can be placed on a four-ton truck, replacement of all the panels has been completed before the stock of new panels on the truck runs out.

As described above, the work support system 1 according to this embodiment dynamically sets, in accordance with a work environment that changes as the plurality of pieces of predetermined work included in the construction work are executed, travel routes for workers to execute the respective pieces of predetermined work. By the above configuration, the work support system 1 according to this embodiment can perform a simulation using information about travel routes that closely resemble the actual travel routes, and therefore can propose a highly accurate work flow to a user. Note that this work support system can improve, through machine learning, the performance of search for travel routes and the performance of calculation of the flow of execution of predetermined work, thereby improving the performance of the simulation.

Note that, in addition to a result of the calculation (a work flow) performed by the work flow calculation unit 14, the output unit 15 may further output information about the workers to whom the pieces of predetermined work have been respectively assigned by the assignment unit 12. For example, the output unit 15 may output information indicating that a worker to whom the work for making holes in support pillars has been assigned is required to have a predetermined qualification.

The present disclosure is not limited to the above-described embodiment and may be changed as appropriate without departing from the scope of the present disclosure.

Further, in the present disclosure, it is possible to implement all or part of processing performed by the work support system 1 by causing a Central Processing Unit (CPU) to execute a computer program.

The above-described program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a Random-Access Memory (RAM), a Read-Only Memory (ROM), a flash memory, a Solid-State Drive (SSD) or other types of memory technologies, a CD-ROM, a Digital Versatile Disc (DVD), a Blu-ray (Registered Trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A work support system comprising:
a travel route setting unit configured to set travel routes for workers respectively assigned to a plurality of pieces of predetermined work to execute the respective pieces of predetermined work;
a work flow calculation unit configured to calculate a work flow showing a flow in which each of the plurality of pieces of predetermined work is executed based on at least a condition for starting execution of each of the pieces of predetermined work, an execution time of each of the pieces of predetermined work, and a travel time during which the workers travel through the respective travel routes to execute the respective pieces of the predetermined work; and
an output unit configured to output a result of the calculation performed by the work flow calculation unit,
wherein the travel route setting unit dynamically sets the travel routes in accordance with a work environment that changes as the plurality of pieces of predetermined work are executed.

2. The work support system according to claim 1, wherein the work environment is a work area for each of the workers respectively assigned to the plurality of pieces of predetermined work, the work area changing as the plurality of pieces of predetermined work are executed.

3. The work support system according to claim 1, wherein the output unit further outputs, in addition to the result of the calculation performed by the work flow calculation unit, information about the workers to whom the pieces of predetermined work have been respectively assigned.

4. A work support method comprising:
setting travel routes for workers respectively assigned to a plurality of pieces of predetermined work to execute the respective pieces of predetermined work;
calculating a work flow showing a flow in which each of the plurality of pieces of predetermined work is executed based on at least a condition for starting execution of each of the pieces of predetermined work, an execution time of each of the pieces of predetermined work, and a travel time during which the workers travel through the respective travel routes to execute the respective pieces of the predetermined work; and
outputting a result of the calculation,
wherein in the setting of the travel routes, the travel routes are dynamically set in accordance with a work environment that changes as the plurality of pieces of predetermined work are executed.

5. A non-transitory computer readable medium storing a work support program for causing a computer to:
set travel routes for workers respectively assigned to a plurality of pieces of predetermined work to execute the respective pieces of predetermined work;
calculate a work flow showing a flow in which each of the plurality of pieces of predetermined work is executed based on at least a condition for starting execution of each of the pieces of predetermined work, an execution time of each of the pieces of predetermined work, and a travel time during which the workers travel through the respective travel routes to execute the respective pieces of the predetermined work; and
output a result of the calculation,
wherein in the setting of the travel routes, the travel routes are dynamically set in accordance with a work environment that changes as the plurality of pieces of predetermined work are executed.
